(19) United States
(12) Patent Application Publication
(10) Pub. No.: US 2024/0193445 A1
(43) Pub. Date: Jun. 13, 2024

(54) DOMAIN-CUSTOMIZABLE MODELS FOR CONVERSATIONAL AI SYSTEMS AND APPLICATIONS

(71) Applicant: NVIDIA Corporation, Santa Clara, CA (US)

(72) Inventors: Yi Dong, Lexington, MA (US); Xianchao Wu, Tokyo (JP)

(21) Appl. No.: 18/064,125

(22) Filed: Dec. 9, 2022

(51) Int. Cl. G06N 5/043; G06F 40/40

(52) U.S. Cl. CPC G06N 5/043; G06F 40/40

(57) ABSTRACT

In various examples, systems and methods are disclosed that train a machine learning model(s)—such as a large language model (LLM)—for one or more specific domains. In some embodiments, the machine learning model(s) may include at least a base model(s) as well as additional parts, such as additional layers, associated with the domains for which the machine learning model(s) is being trained. As such, the parts of the machine learning model(s) may be trained separately, such that training data associated with a domain is used to train a part of the machine learning model(s) that is associated with the domain without training the other part(s) of the machine learning model(s). The systems and methods may then use these parts when deploying the machine learning model(s), such as by activating and/or deactivating parts based on the input data being processed.

### BACKGROUND

Language models are used in many different applications, such as to schedule travel plans (e.g., booking arrangements for transportation and accommodations etc.), plan activities (e.g., making reservations, etc.), communicate with others (e.g., make phone calls, start video conferences, etc.), shop for items (e.g., purchase items from online marketplaces, etc.), and/or other use cases. Some language models operate by receiving text—such as text including one or more letters, words, sub-words, characters, numbers, and/or symbols—that is generated using an input device and/or generated as a transcript of spoken language. In some circumstances, the text may be specific to a domain, such as a financing domain, a travel domain, a communications domain, a computer science domain, and/or so forth. The language models then process the text and, based on the processing, output data that is related to the text.

Current language models are trained to understand multiple domains. For example, during training, parameters (e.g., weights and/or biases) of layers of the language models are updated using training data that is related to each of the domains (e.g., training data related to the financial domain, training data related to the travel domain, etc.). While such language models may be useful for more general applications, in many circumstances, a user may only need a language model that understands one or more specific domains. For example, a banking application may need a language model that understands the financing domain without necessarily understanding other domains, such as the travel domain or the computer science domain. Because of this, and based on the sizes of the language models, it may not be economical and/or computationally practical to deploy one of these language models trained for many domains for use in only a specific domain application.

As such, some approaches have been used to train the language models for specific domains. For example, to better train one of these language models for a specific domain, a system may perform additional training using training data that is related to the specific domain in order to further update the parameters of the layers of the language model. However, such training may cause the language model to be less accurate or precise for understanding other domains. Additionally, such training may require a very large training set due to the size of the language models that need to be updated.

### SUMMARY

Embodiments of the present disclosure relate to domain-customizable models for conversational AI systems and applications. Systems and methods are disclosed that train one or more machine learning models—such as large language models (LLMs)—to understand one or more specific domains. In some embodiments, the machine learning model(s) may include at least a base model(s) as well as additional domain specific parts, such as additional layers, associated with the domains for which the machine learning model(s) is being trained. As such, the domain specific parts of the machine learning model(s) may be trained separately, such that training data associated with a domain is used to train a domain specific part of the machine learning model(s) without training the other domain specific part(s) of the machine learning model(s). The systems and methods may then use these domain specific parts when deploying the machine learning model(s). For example, if the machine learning model(s) is being used for a specific domain, the domain specific part of the machine learning model(s) that is associated with the specific domain may be activated (e.g., added to the base model(s), connected to the base model(s), etc.) while the domain specific part(s) of the machine learning model(s) that is associated with the other domain(s) may be deactivated (e.g., removed from the base model(s), disconnected from the base model(s), etc.).

In contrast to conventional systems, such as those described above, the machine learning model(s) of the current systems, in some embodiments, may be broken into the various domain specific parts, where a respective domain specific part is trained for a specific domain. This may reduce the amount of data and/or computing resources that are required to train the machine learning model(s) as compared to conventional language models of the conventional systems. For instance, and as discussed above, to train a conventional language model for a specific domain, an entirety of the layers of the language model may need to be updated, which may require not only retraining on the original large training set for all layers, but also on additional data for the specific domain. In contrast, to train the portions of the machine learning model(s) described herein for a specific domain, only the layers of the domain specific part that is associated with the specific domain (and/or a portion of the layers of the base model(s)) may need to be trained and the rest of the layers of the machine learning model(s) may not require additional training, which may thus require less training time and compute resources.

Additionally, by activating and/or deactivating domain specific parts of the machine learning model(s) based on the domains for which the machine learning model(s) is deployed, the machine learning model(s) of the current systems may be more accurate, require fewer computing resources, and/or have less latency when processing input data. For instance, and as also discussed above, conventional language models may process input data using an entirety of the layers of the language models since the layers of the language models are not removable. As such, the conventional language models may process input data using a greater number of layers as compared the machine learning models(s) described herein, which may require a greater amount of computing resources and/or increase the processing latency of the conventional language models. Additionally, the conventional language models may process the input data without additional layers that have been trained for a specific domain, thereby losing the benefit of the improved accuracy or precision with respect to specific domains. In contrast, the machine learning model(s) described herein may process input data using the base model(s) in addition to one or more layers that were specifically trained for the domain related to the input data. Where different sets of layers are trained in this way for specific domains, the set of layers corresponding a domain of a current input may be activated while other sets of layers may be deactivated and/or may not be included in the deployed model.

### BRIEF DESCRIPTION OF THE DRAWINGS

The present systems and methods for domain-customizable models for conversational AI systems and applications are described in detail below with reference to the attached drawing figures, wherein:

FIG. 1A illustrates an example of training a machine learning model(s) that includes a base model(s) and domain specific parts, in accordance with some embodiments of the present disclosure;

FIG. 1B illustrates an example of deploying the machine learning model(s) from the example of FIG. 1A, in accordance with some embodiments of the present disclosure;

FIG. 2A illustrates an example of training a base model(s) of a machine learning model(s), in accordance with some embodiment of the present disclosure;

FIG. 2B illustrates an example of training a domain specific part of the machine learning model(s) from the example of FIG. 2A, in accordance with some embodiment of the present disclosure;

FIG. 3A illustrates another example of training a base model(s) of a machine learning model(s), in accordance with some embodiments of the present disclosure;

FIG. 3B illustrates an example of training a domain specific part of the machine learning model(s) from the example of FIG. 3A, in accordance with some embodiment of the present disclosure;

FIG. 4A illustrates an example of deploying the machine learning model(s) from the example of FIG. 3A, in accordance with some embodiments of the present disclosure;

FIG. 4B illustrates an example of deploying the machine learning model(s) from the example of FIG. 3A, in accordance with some embodiments of the present disclosure;

FIG. 5 is a data flow diagram illustrating a process for training a machine learning model(s), in accordance with some embodiments of the present disclosure;

FIGS. 6A-6C illustrate examples of applying a machine learning model(s) with one or more additional models, in accordance with some embodiments of the present disclosure;

FIG. 7 is a first flow diagram showing a first method for deploying a machine learning model(s) that includes a base model(s) and domain specific parts, in accordance with some embodiments of the present disclosure;

FIG. 8 is a second flow diagram showing a second method for deploying a machine learning model(s) that includes a base model(s) and domain specific parts, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to domain-customizable models for conversational AI systems and applications. The systems and methods described herein may be used for a variety of purposes, by way of example and without limitation, in systems associated with machine control, machine locomotion, machine driving, in-vehicle infotainment, synthetic data generation, model training, perception, augmented reality, virtual reality, mixed reality, robotics, security and surveillance, simulation and digital twinning, autonomous or semi-autonomous machine applications, deep learning, environment simulation, speech processing, data center processing, conversational AI, digital avatars, chat bots, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing speech processing, systems implemented using an edge device, systems incorporating one or more virtual machines (VMs), systems for performing synthetic data generation operations, systems implemented at least partially in a data center, systems for performing conversational AI operations, digital avatar systems, chat bot systems, systems for performing light transport simulation, systems for performing collaborative content creation for 3D assets, systems implemented at least partially using cloud computing resources, and/or other types of systems.

For instance, a machine learning model(s)—such as a large language model (LLM)—may include a base model(s) and domain specific parts that may be activated and/or deactivated, or may be deployed or not deployed, which is described in more detail herein. The base model(s) may include layers that are trained using training data (general-purpose training data) associated with multiple domains. As described herein, a domain may include, but is not limited to, a financing domain, a travel domain, a communications domain, a computer science domain, an automotive domain, an electronics domain, a real estate domain, and/or any other type of domain. A domain specific part may include additional layers that are trained using training data that is specific to the domain. For example, a first domain specific part may include first layers that are trained using training data associated with the financing domain, a second domain specific part may include second layers that are trained using training data associated with the travel domain, and/or so forth. The different layer(s) for the different domains may be organized horizontally (in parallel), in embodiments. For example, a financial domain may include neural network layers 1-10, travel domain may include different neural network layers layer 1-10. The inputs may then be sent in parallel to layers of both domains, and their outputs may be merged before the final output layer. In some examples, a domain specific part may be stored using a separate memory from the base model(s), such that the domain specific part may be activated and/or deactivated, and/or may be deployed or not deployed depending on the domain space of the deployment.

In some examples, a system(s) may train the machine learning model(s) in multiple steps. For example, the system(s) may perform a step that includes training the base model(s) without training the domain specific parts. To perform this step, the system(s) may “freeze” the domain specific parts such that weights and/or parameters of the layers of the domain specific parts are not updated during training while weights and/or parameters of the layers of the base model(s) are updated during the training. The system(s) may then perform one or more steps to train one or more of the domain specific parts. For instance, to train a domain specific part, the system(s) may “freeze” one or more layers of the base model(s) and the layers of the other domain specific part(s) of the machine learning model(s) such that weights and/or parameters of the one or more layers of the base model(s) and weights and/or parameters of the layers of the other domain specific part(s) are not updated during training while weights and/or parameters of the layers of the domain specific part being trained are updated during training.

The system(s) may then deploy the machine learning model(s) to one or more users. In some examples, the system(s) may deploy the entire machine learning model(s), which includes the base model(s) and each of the domain specific parts. However, in other examples, the system(s) may deploy only a portion of the machine learning model(s), such as the base model(s) and one or more of the domain specific parts. For example, if the machine learning model(s) includes four domain specific parts associated with four specific domains, and a user only wants to use the machine learning model(s) for processing input data associated with two of the specific domains, then the system(s) may provide the user with the base model(s) and the domain specific parts of the machine learning model(s) that are associated with the two specific domains. By deploying the machine learning model(s) using such a process, the system(s) does not have to deploy the entire machine learning model(s) (e.g., the domain specific parts that are associated with the other domains), which may save computing resources.

As described herein, the domain specific parts of the machine learning model(s) may be activated and/or deactivated, such as based on the type of input data being processed by the machine learning model(s). In some examples, to activate a domain specific part of the machine learning model(s), the domain specific part may be added and/or connected to the base model(s). For instance, one or more layers of the domain specific part may be communicatively coupled to one or more layers of the base model(s). In some examples, to deactivate a domain specific part of the machine learning model(s), the domain specific part may be removed and/or disconnected from the base model(s). For instance, one or more layers of the domain specific part may be communicatively decoupled from one or more layers of the base model(s).

In some examples, a domain specific part may be activated and/or deactivated based on input from a user. For instance, if the user is using the machine learning model(s) for processing input data associated with a specific domain, then the user may provide input to activate the domain specific part of the machine learning model(s) associated with the domain while deactivating the other domain specific part(s). In some examples, a domain specific part may be activated and/or deactivated based on an analysis of the input data being processed by the machine learning model(s). For instance, if the input data is associated with a specific domain, then the domain specific part of the machine learning model(s) associated with the domain may be activated while the other domain specific part(s) are deactivated.

As described herein, when a domain specific part of the machine learning model(s) is activated, the machine learning model(s) may better understand input data that corresponds to a domain associated with the domain specific part. For instance, if the domain specific part of the machine learning model(s) that is associated with the financing domain is activated, then the machine learning model(s) may better understand input data corresponding to the financing domain. Additionally, when a domain specific part of the machine learning model(s) is deactivated, the machine learning model(s) may be less optimized to understand input data that corresponds to a domain associated with the domain specific part. For instance, if the domain specific part of the machine learning model(s) that is associated with the financing domain is deactivated, then the machine learning model(s) may produce less accurate or precise outputs from input data corresponding to the financing domain.

In some examples, the machine learning model(s) may be used with one or more other models, such as one or more language models, in order to increase the performance of the other model(s). For example, the machine learning model(s) may be added to a general model such that the machine learning model(s) and the general model each process input data and output respective data, such as data representing vector or tensor representations. The data output from the two models may then be combined (e.g., concatenated) to generate a final output. In some examples, one or more additional models, such as one or more scoring models, may also be used to process the data output by the models and/or the combined data in order to determine the final output. For example, if the data output by the models includes a given number of results, then the scoring model(s) may score the results and select one of the results (e.g., the highest scoring results) for the final output.

While the examples herein describe the parts of the machine learning model(s) as being associated with specific domains, in other examples, the parts may be associated with other types of input data. For example, a part may be trained to understand input data associated with different intents (e.g., booking travel, requesting information, interpreting information, etc.), different tasks (e.g., with regard to booking travel, booking a plane flight, booking a cruise, booking a hotel, etc.), and/or the like.

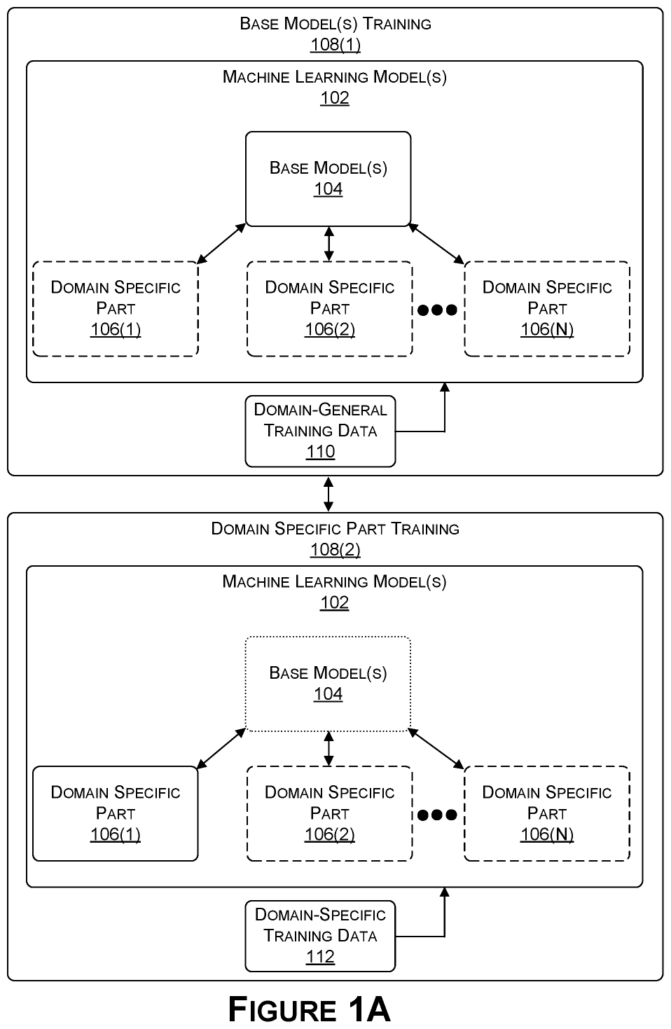

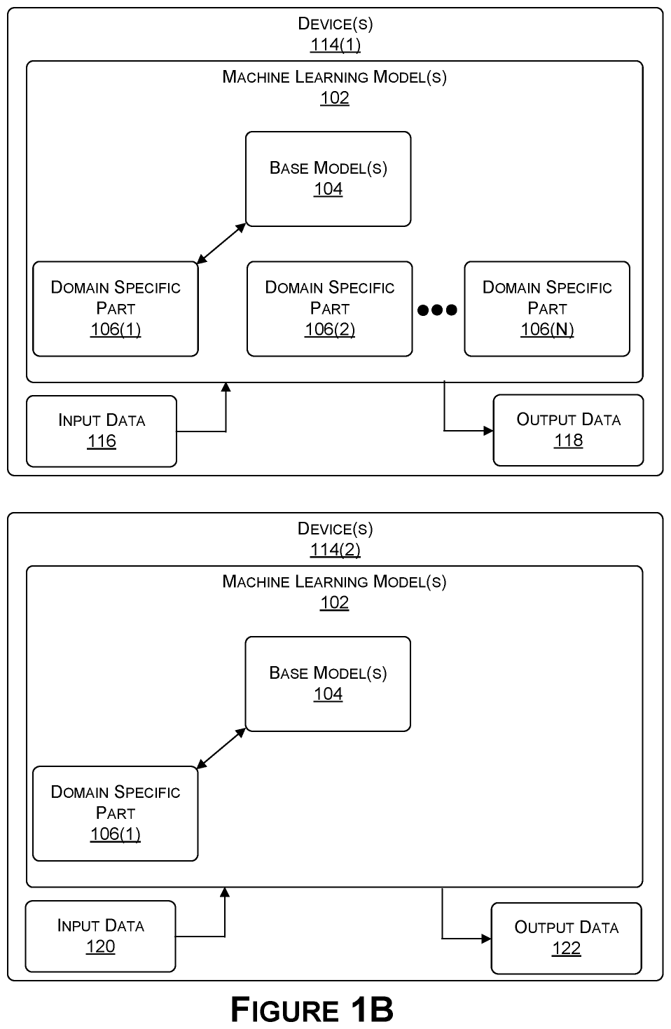

With reference to FIG. 1A, FIG. 1A illustrates an example of training a machine learning model(s) 102 that includes a base model(s) 104 and domain specific parts 106(1)-(N) (also referred to singularly as “domain specific part 106” or in plural as “domain specific parts 106”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown by the example of FIG. 1A, the machine learning model(s) 102—such as a large language model (LLM)—may be trained using multiple steps, such as a base model(s) training step 108(1) and one or more domain specific part steps 108(2). During the base model(s) training step 108(1), layers of the base model(s) 104 may be “unfrozen,” which is represented by the solid line, while layers of the domain specific parts 106 are “frozen,” with is represented by the dashed lines. As described herein, when a layer is frozen, one or more weights and/or parameters associated with the layer may not be updated during training, such as during back propagation. Additionally, when a layer is unfrozen, one or more weights and/or parameters of the layer may be updated during training, such as during the back propagation. In some examples, the domain specific parts 106 may be associated with memory units. For instance, the domain specific part 106(1) may represent a first memory unit that stores first layers associated with a first specific domain, the domain specific part 106(2) may represent a second memory that stores second layers associated with a second specific domain, and/or so forth. As such, and in such examples, freezing the domain specific parts 106 may include freezing the memory units.

The base model(s) 104 may include a general-purpose model(s) that is trained to understand multiple domains, such as using a general domain dataset (including basic conversational language for any number of domains) that does not include (although it may) specific domain datasets (e.g., math, finance, medical, etc.). As such, the base model(s) 104 may be trained using domain-general training data 110 that is associated the multiple domains. For example, the domain-general training data 110 may include training data corresponding to general domains, such as basic conversational language, which may or may not include information associated with a financing domain, training data associated with a travel domain, training data associated with an automotive domain, and/or so forth. In such examples, the general-purpose training data set may not be fine-tuned or focused on specific domains, but may include language that happens to correspond to various different domains, or more generally to common language shared among different domains. In some examples, during the training, the domain-general training data 110 may be processed using the layers of the base model(s) 104 as well as the layers of the domain specific parts 106. However, and as described herein, the weights and/or parameters of the layers of the base model(s) 104 are updated while the weights and/or parameters of the domain specific parts 106 are not updated, such as during back propagation.

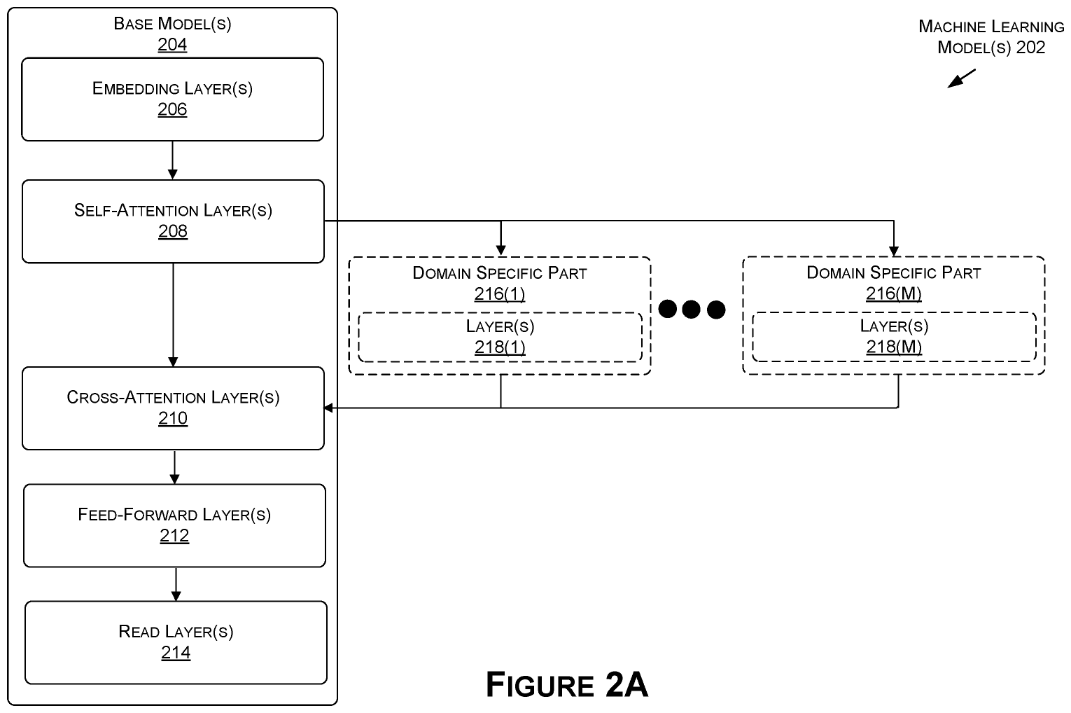

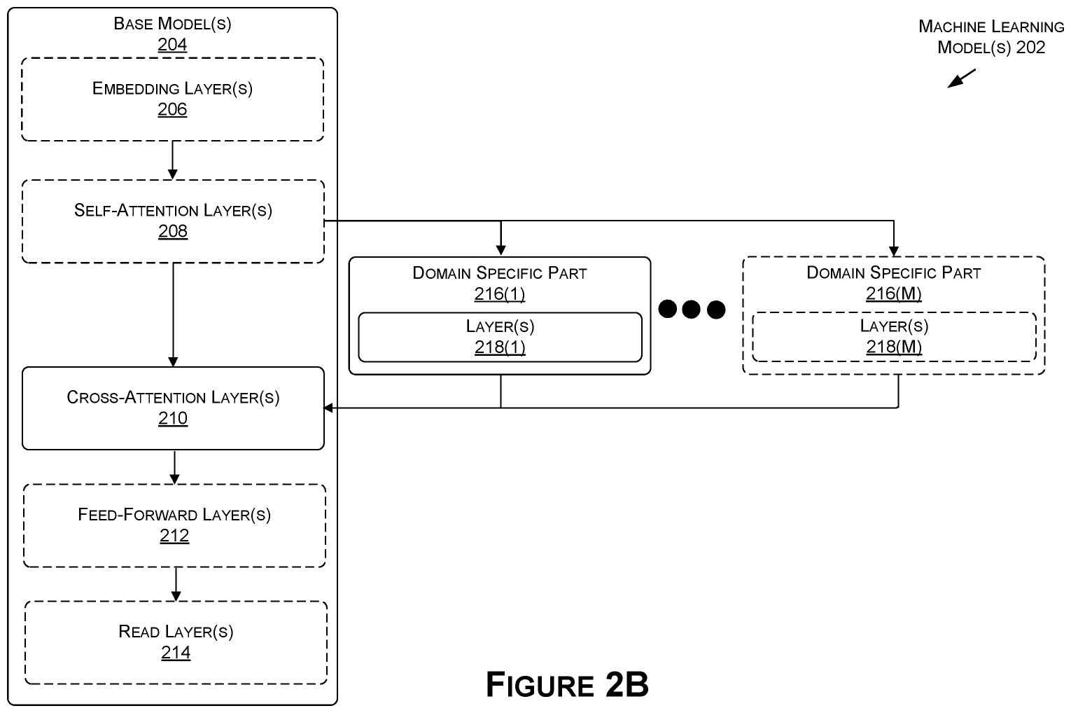

For instance, FIG. 2A illustrates a first example of training a base model(s) of a machine learning model(s) 202 (which may represent, and/or include, the machine learning model(s) 102), in accordance with some embodiments of the present disclosure. As shown, a base model(s) 204 of the machine learning model(s) 202 may include multiple layers, such as an embedding layer(s) 206, a self-attention layer(s) 208, a cross-attention layer(s) 210, a feed-forward layer(s) 212, and a read layer(s) 214. However, in other examples, the base model(s) 204 of the machine learning model(s) 202 may include additional and/or alternative layers. The machine learning model(s) 202 may also include a domain specific part 216(1) (e.g., a memory unit) that includes one or more layers 218(1) and a domain specific part 216(M) (e.g., a memory unit) that includes one or more layers 218(M).

In the example of FIG. 2A, the domain specific part 216(1) is connected to the self-attention layer(s) 208 and the cross-attention layer(s) 210. For example, a first layer 218(1) may be connected to one or more of the self-attention layer(s) 208 and a second layer 218(1) may be connected to one or more of the cross-attention layer(s) 210. Additionally, the domain specific part 216(M) is connected to the self-attention layer(s) 208 and the cross-attention layer(s) 210. For example, a first layer 218(M) may be connected to one or more of the self-attention layer(s) 208 and a second layer 218(M) may be connected to one or more of the cross-attention layer(s) 210. In some examples, the domain specific parts 216(1)-(M) may be connected to the same self-attention layer(s) 208 and/or the same cross-attention layer(s) 210. In other examples, the domain specific parts 216(1)-(M) may be connected to different self-attention layer(s) 208 and/or different cross-attention layer(s) 210.

For instance, and in some examples, the machine learning model(s) 202 may include a transformer decoder where the machine learning model(s) 202 models the sequences of input tokens by casual self-attention. The cross-attention layer(s) 210 may be configured to integrate the information from the self-attention layer(s) 208 and the domain specific parts 216(1)-(M). In some examples, the domain specific parts 216(1)-(M) may represent a transformer encoder that uses bi-directional attention or casual attention. For instance, the domain specific parts 216(1)-(M) may take the output from the self-attention layer(s) 208 and then process the output to generate a key(s) or a value(s), which is then output to the cross-attention layer(s) 210. In some examples, since the domain specific parts 216(1)-(M) are associated with different domains, the domain specific parts 216(1)-(M) may generate keys and/or values for the different domains. Because of this, a query matrix may be computed from the decoder and used to query the key and value matrices. This information may then be combined together for the next block to process.

To train the base model(s) 204, the embedding layer(s) 206, the self-attention layer(s) 208, the cross-attention layer(s) 210, the feed-forward layer(s) 212, and the read layer(s) 214 may be unfrozen, which is indicated by the solid lines. Additionally, the domain specific parts 216(1)-(M) (e.g., the layer(s) 218(1)-(M)) may be frozen, which is indicated by the dashed lines. As such, the weights and/or parameters associated with the embedding layer(s) 206, the self-attention layer(s) 208, the cross-attention layer(s) 210, the feed-forward layer(s) 212, and the read layer(s) 214 may be updated during the training while weights and/or parameters associated with the layer(s) 218(1)-(M) may not be updated during the training.

In some examples, the base model(s) 204 is trained to know how to access information from the domain specific parts 216(1)-(M). For instance, the base model(s) 204 may be trained to understand the general domain data. In some examples, during training, a dropout may be applied to the outputs from the domain specific parts 216(1)-(M) so that the base model(s) 204 learn how to integrate information from the domain specific parts 216(1)-(M) even when the one or more of the domain specific parts 216(1)-(M) are deactivated, such as during deployment, which is described in more detail herein.

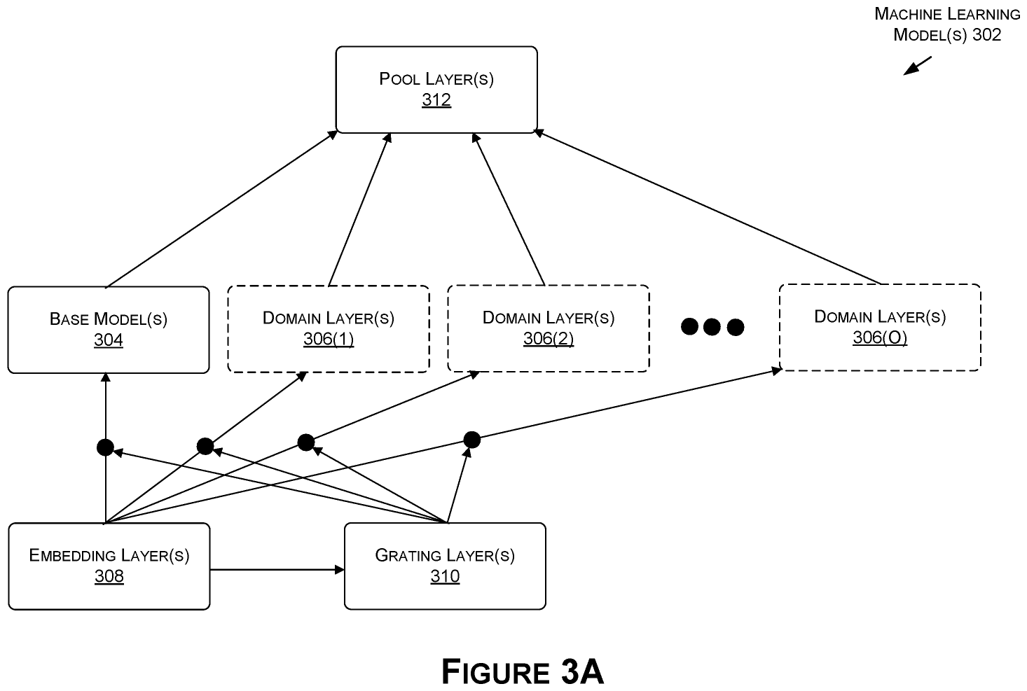

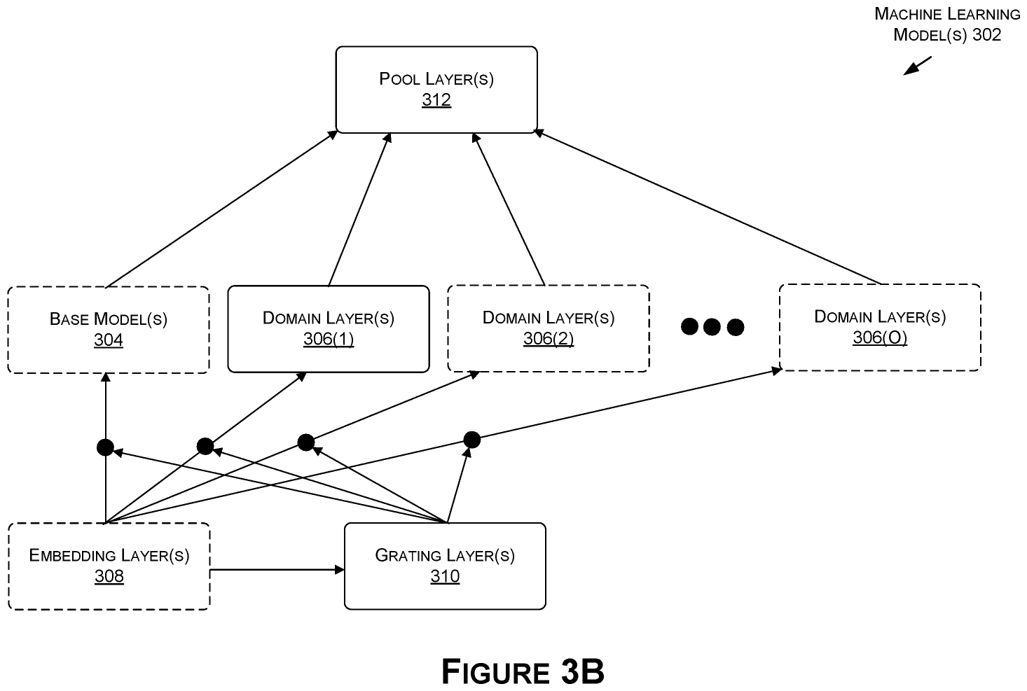

Additionally, FIG. 3A illustrates a second example of training a base model(s) of a machine learning model(s) 302 (which may represent, and/or include, the machine learning model(s) 102), in accordance with some embodiments of the present disclosure. As shown, the machine learning model(s) 302 may include a base model(s) 304, domain specific parts 306(1)-(O) (e.g., memory units), and one or more other layers, such as an embedding layer(s) 308, a gating layer(s) 310, and a pool layer(s) 312. However, in other examples, the machine learning model(s) 302 may include additional and/or alternative layers. In some examples, the base model(s) 304 and the domain specific parts 306(1)-(O) may be implemented as transformer decoders.

The gating layer(s) 310, which may include a spare gating layer(s), may be configured to select the route based on the input data. For instance, and as described herein, each of the domain specific parts 306(1)-(O) may be associated with a respective domain. As such, the gating layer(s) 310 may assign different route numbers to the different domain specific parts 306(1)-(O). For example, a gating route number of zero may control the route from the input to the domain specific part 306(1), a gating route number of one may control the route from the input to the domain specific part 306(2), and/or so forth. Since the number of domain specific parts 306(1)-(O) is dynamic (e.g., based on the domain specific parts 306(1)-(O) being activated and deactivated), the gating layer(s) 310 may receive one or more masks from the domain specific parts 306(1)-(O). As such, if a domain specific part 306(1)-(O) is deactivated, then the gating layer(s) 310 may mask the route to the domain specific part 306(1)-(O).

To train the base model(s) 304, the base model(s) 304 (e.g., the layer(s) of the base model(s) 304), the embedding layer(s) 308, the gating layer(s) 310, and the pool layer(s) 312 may be unfrozen, which is indicated by the solid lines. Additionally, the domain specific parts 306(1)-(O) (e.g., the layer(s) of the domain specific parts 306(1)-(O)) may be frozen, which is indicated by the dashed lines. As such, the weights and/or parameters associated with the base model(s) 304 (e.g., the layer(s) of the base model(s) 304), the embedding layer(s) 308, the gating layer(s) 310, and the pool layer(s) 312 may be updated during the training while weights and/or parameters associated with the layers of the domain specific parts 306(1)-(O) may not be updated during the training.

Referring back to the example of FIG. 1A, during the domain specific part training step 108(2), the layers of the domain specific part 106(1) being trained may be “unfrozen,” which is represented by the solid line, and the layers of the domain specific parts 106(2)-(N) not being trained may be frozen,” which is represented by the dashed line. Additionally, one or more first layers of the base model(s) 104 may be “frozen” and/or one or more second layers of the base model(s) 104 may be “unfrozen,” which is represented by the dotted line. For instance, in some examples, all of the layers of the base model(s) 104 may be frozen during training of the domain specific parts 106. In other examples, one or more layers of the base model(s) 104 may be frozen while one or more other layers of the base model(s) 104 may be unfrozen during the training of the domain specific parts 106. In such examples, the one or more other layers may include the layer(s) of the base model(s) 104 that send data to and/or receive data from the domain specific parts 106.

As described herein, the domain specific parts 106 may be trained to understand specific domains. For example, the domain specific part 106(1) may be trained to understand data associated with a first specific domain (e.g., the financing domain), the domain specific part 106(2) may be trained to understand data associated with a second specific domain (e.g., the travel domain), and/or so forth. As such, the domain specific part 106(1) may be trained using domain-specific training data 112 that is associated the specific domain of the domain specific part 106(1). For example, and again if the domain specific part 106(1) is associated with the financing domain, then the domain-specific training data 112 may include data associated with the financial domain.

In some examples, during the training of the domain specific part 106(1), the domain-specific training data 112 may be processed using the layers of the base model(s) 104 as well as the layers of the domain specific parts 106. However, and as described herein, the weights and/or parameters of the layers of the domain specific part 106(1) are updated while the weights and/or parameters of the domain specific parts 106(2)-(N) are not updated. Additionally, the weights and/or parameters of the one or more frozen layers of the base model(s) 104 may not be updated while the weights and/or parameters of the unfrozen layers of the base model(s) 104 are updated.

For instance, FIG. 2B illustrates a first example of training a domain specific part of the machine learning model(s) 202, in accordance with some embodiments of the present disclosure. To train the domain specific part 216(1), the layer(s) 218(1) of the domain specific part 216(1) and the cross-attention layer(s) 210 may be unfrozen, which is represented by the solid lines. Additionally, the embedding layer(s) 206, the self-attention layer(s) 208, the feed-forward layer(s) 212, the read layer(s) 214, and the layer(s) 218(2) of the domain specific part 216(2) may be frozen, which is indicated by the dashed lines. As such, the weights and/or parameters associated with the layer(s) 218(1) of the domain specific part 216(1) and the cross-attention layer(s) 210 may be updated during the training while the weights and/or parameters of the embedding layer(s) 206, the self-attention layer(s) 208, the feed-forward layer(s) 212, the read layer(s) 214, and the layer(s) 218(M) of the domain specific part 216(M) may not be updated during the training.

In some examples, the cross-attention layer(s) 210 may remain unfrozen in order to further train the cross-attention layer(s) 210 learn how to integrate the information from the domain specific parts 216(1)-(M). Additionally, in some examples, and similar to the training of the base model(s) 204, a dropout may be applied to the outputs from the domain specific part 216(M) so that the base model(s) 204 learns how to integrate information from the domain specific parts 216(1)-(M) even when one or more of the domain specific parts 216(1)-(M) are deactivated, such as during deployment, which is described in more detail herein.

Additionally, FIG. 3B illustrates a second example of training a domain specific part of the machine learning model(s) 302, in accordance with some embodiments of the present disclosure. To train the domain specific part 306(1), the domain specific part 306(1) (e.g., the layer(s) of the domain specific part 306(1)), the gating layer(s) 310, and the pool layer(s) 312 may be unfrozen, which is represented by the solid lines. Additionally, the base model(s) 304 (e.g., the layer(s) of the base model(s) 304), the embedding layer(s) 308, and the domain specific parts 306(2)-(O) (e.g., the layer(s) of the domain specific parts 306(2)-(O)) may be frozen, which is indicated by the dashed lines. As such, the weights and/or parameters associated with the domain specific part 306(1) (e.g., the layers of the domain specific part 306(1)), the gating layer(s) 310, and the pool layer(s) 312 may be updated during the training while the weights and/or parameters of the base model(s) 304 (e.g., the layers of the base model(s) 304), the embedding layer(s) 308, and the domain specific parts 306(2)-(O) (e.g., the layers of the domain specific parts 306(2)-(O)) may not be updated during the training.

In some examples, the gating layer(s) 310 remains unfrozen while the base model(s) 304 is frozen in order to further train the gating layer(s) 310 to determine which domain specific part 306(1)-(O) (e.g., the domain specific part 306(1) in the example of FIG. 3B) to send the input. Additionally, in some examples, a dropout may be applied to the masks of the domain specific parts 306(1)-(O) (e.g., the domain specific parts 306(2)-(O) in the example of FIG. 3B) that are not being trained so that the gating layer(s) 310 is trained to determine how to operate when the domain specific parts 306(1)-(O) are deactivated.

Referring back to the example of FIG. 1A, each of the other domain specific parts 106(2)-(N) may be trained using a similar process as the domain specific part 106(1). This way, each of the domain specific parts 106 may respectively be trained to understand a specific domain. In some examples, two or more (e.g., each) of the domain specific parts 106 may include a same number of layers that are trained. In other examples, the domain specific parts 106 may include a different number of layers. For example, the number of layers of the domain specific parts 106 may depend on the amount of training data that is used to train the domain specific parts 106. For instance, a domain specific part 106 that is trained using a first amount of training data may include a first number of layers while a domain specific part 106 that is trained using a second, greater amount of training data may include a second, greater number of layers. In other words, in some examples, the number of layers of the domain specific parts 106 may increase as the amount of training data also increases.

During and/or after training, the machine learning model(s) 102 may be deployed to one or more users. For instance, FIG. 1B illustrates a system for deploying the machine learning model(s) 102 from the example of FIG. 1A, in accordance with some embodiments of the present disclosure. For instance, and for a first deployment(s), the system(s) may provide (e.g., send) an entirety of the machine learning model(s) 102, such as the base model(s) 104 and each of the domain specific parts 106, to a device(s) 114(1). As described herein, a device 114(1) may include, but is not limited to, a system, a server, a machine, a computer, a mobile device, and/or any other type of device.

Since the entirety of the machine learning model(s) 102 is deployed, a determination may then be made as to which of the domain specific parts 106 to activate and which domain specific parts 106 to deactivate. In some examples, the determination is made based on receiving an input, such as an input from a user of the device(s) 114(1), indicating which of the domain specific parts 106 to activate and which of the domain specific parts 106 to deactivate. Additionally, or alternatively, in some examples, the determination is made based on an analysis of input data 116 that is to be processed by the machine learning model(s) 102. For example, the device(s) 114(1) and/or the machine learning model(s) 102 may determine, based on the analysis of the input data 116, that the input data 116 is related to a specific domain. In response, the device(s) 114(1) and/or the machine learning model(s) may activate the domain specific part 106 associated with the specific domain while deactivating the other domain specific parts 106.

For instance, and in the example of FIG. 1B, a determination may be made to activate the domain specific part 106(1), which is indicated by the connection between the domain specific part 106(1) and the base model(s) 104, and deactivate the domain specific parts 106(2)-(N), which is indicated by there being no connection between the domain specific parts 106(2)-(N) and the base model(s) 104. As described herein, the domain specific parts 106(2)-(N) may be deactivated by removing the memory units associated with the domain specific parts 106(2)-(N), terminating the connections between the domain specific parts 106(2)-(N) and the base model(s) 104, and/or performing one or more additional and/or alternative techniques.

At the first deployment(s) to the device(s) 114(1), the input data 116 may be input into the machine learning model(s) 102 for processing. For instance, the machine learning model(s) 102 may process the input data 116 using the base model(s) 104 as well as the domain specific part 106(1), but without processing the input data 116 using the domain specific parts 106(2)-(N). Based on the processing, the machine learning model(s) 102 may output data 118. The output data 118 may include, but is not limited to, data representing a vector(s) and/or a tensor(s), data representing a token(s), data representing text, data representing an image, and/or any other type of data.

As further illustrated in the example of FIG. 1B, at a second deployment(s), the system(s) may provide only a portion of the machine learning model(s) 102, such as the base model(s) 104 and the domain specific part 106(1), to a device(s) 114(2). In some examples, the system(s) may determine which of the domain specific parts 106 to send along with the machine learning model(s) 102, such as based on input from a user(s) of the device(s) 114(2). For example, a user for which the machine learning model(s) 102 is being deployed may indicate that the machine learning model(s) 102 is mainly and/or only going to be used to process data associated with a specific domain. As such, the system(s) may just send the base model(s) 104 and the domain specific part 106(1) that is associated with the specific domain. In such an example, sending only a portion of the machine learning model(s) 102 may save computing and/or network resources.

At the second deployment(s), input data 120 may be input into the machine learning model(s) 102 for processing. For instance, the machine learning model(s) 102 may process the input data 120 using the base model(s) 104 as well as the domain specific part 106(1), but without processing the input data 120 using the domain specific parts 106(2)-(N) since the machine learning model(s) 102 does not include the domain specific parts 106(2)-(N). Based on the processing, the machine learning model(s) 102 may output data 122. The output data 122 may include, but is not limited to, data representing a vector(s) and/or tensor(s), data representing a token(s), data representing text, data representing an image, and/or any other type of data.

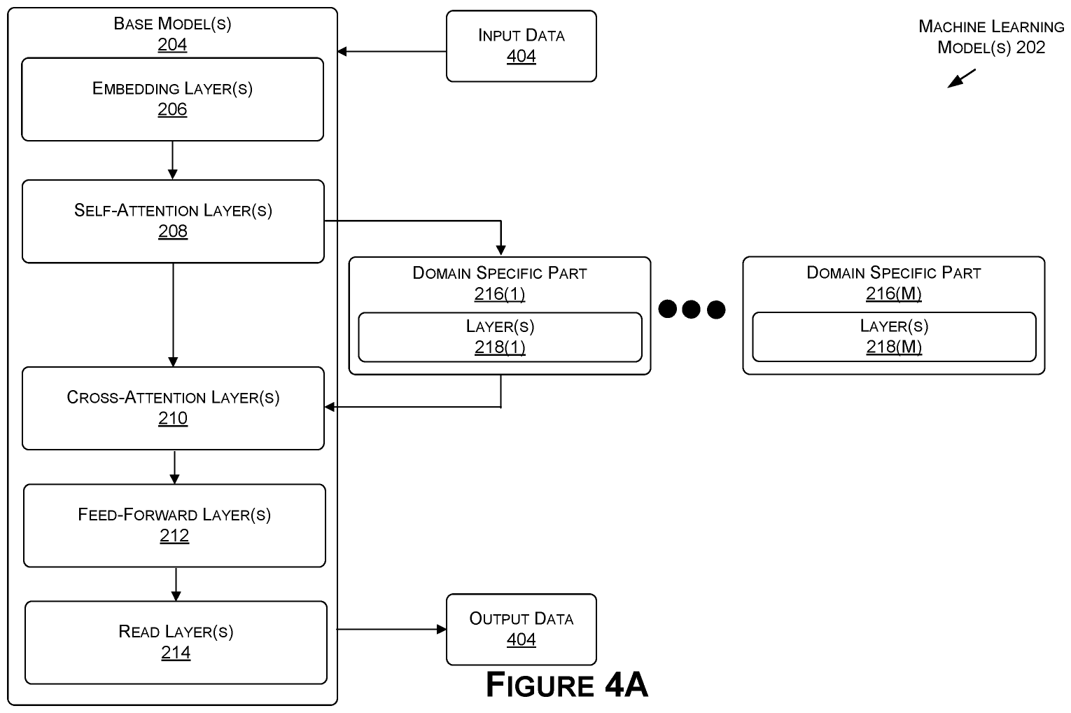

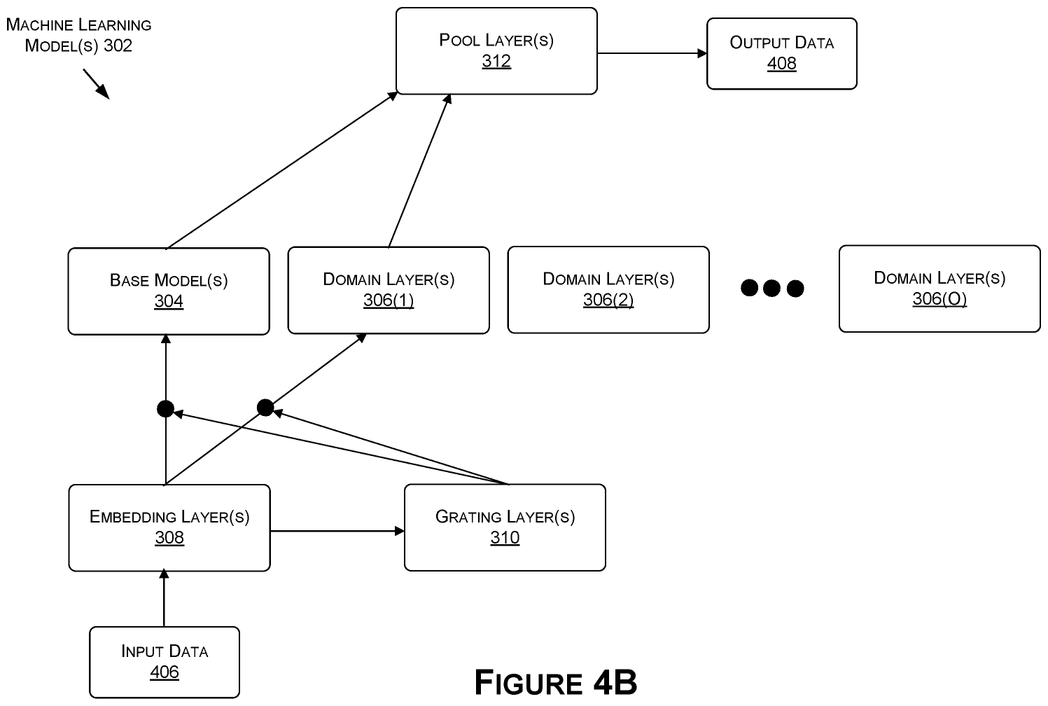

FIG. 4A illustrates an example of deploying the machine learning model(s) 202, in accordance with some embodiments of the present disclosure. As shown, the entire machine learning model(s) 202 may have been deployed, including each of the domain specific parts 216(1)-(M). However, in other examples, one or more of the domain specific parts 216(1)-(M) may not have been deployed. In the example of FIG. 4A, the machine learning model(s) 202 may be used to process input data 402 associated with a specific domain, such as the domain associated with the domain specific part 216(1). As such, the domain specific part 216(1) is activated while the other domain specific part 216(M) is deactivated. The machine learning model(s) 202 may then process the input data 402 using the base model(s) 204 as well as the domain specific part 216(1), but without processing the input data 402 using the domain specific part 216(M) since the domain specific part 216(M) is deactivated. Based on the processing, the machine learning model(s) 202 may output data 404. The output data 404 may include, but is not limited to, data representing a vector(s) and/or a tensor(s), data representing a token(s), data representing text, data representing an image, and/or any other type of data.

Additionally, FIG. 4B illustrates an example of deploying the machine learning model(s) 302, in accordance with some embodiments of the present disclosure. As shown, the entire machine learning model(s) 302 may have been deployed, including each of the domain specific parts 306(1)-(O). However, in other examples, one or more of the domain specific parts 306(1)-(O) may not have been deployed. In the example of FIG. 4B, the machine learning model(s) 202 may be used to process input data 406 associated with a specific domain, such as the domain associated with the domain specific part 306(1). As such, the domain specific part 306(1) is activated while the other domain specific parts 306(2)-(O) are deactivated. The machine learning model(s) 202 may then process the input data 406 using the base model(s) 304, the domain specific part 306(1), the embedding layer(s) 308, the gating layer(s) 310, and the pool layer(s) 312, but without processing the input data 406 using the domain specific parts 306(2)-(O) since the domain specific parts 306(2)-(O) are deactivated. Based on the processing, the machine learning model(s) 302 may generate output data 408. The output data 408 may include, but is not limited to, data representing a vector(s) and/or a tensor(s), data representing a token(s), data representing text, data representing an image, and/or any other type of data.

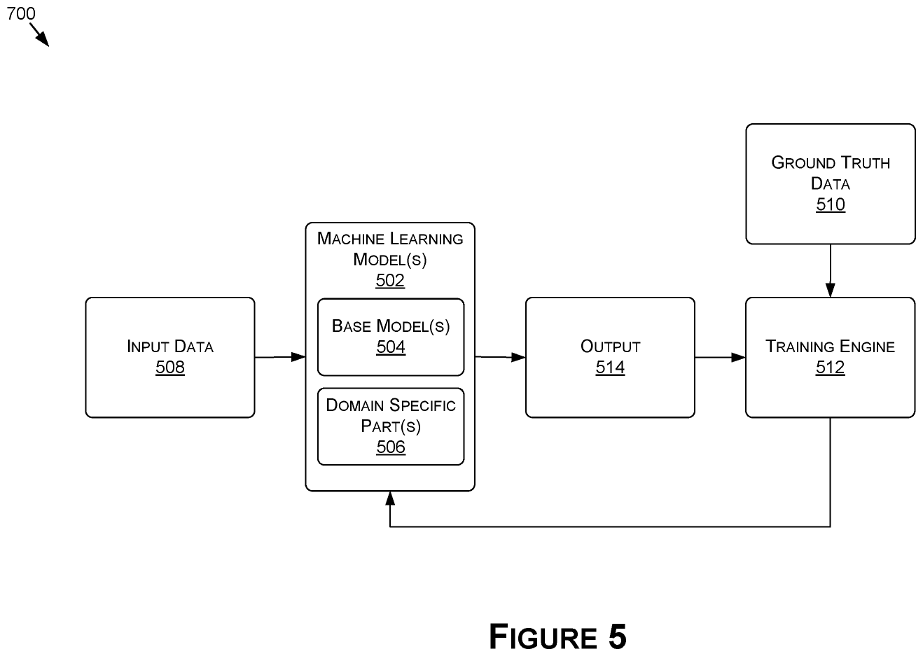

As discussed above, a system(s) may perform various processes in order to train the machine learning model(s). As such, FIG. 5 is a data flow diagram illustrating a process for training a machine learning model(s) 502 (which may represent, and/or include, the machine learning model(s) 102, the machine learning model(s) 202, and/or the machine learning model(s) 302), in accordance with some embodiments of the present disclosure. As shown, the machine learning model(s) 502, which includes a base model(s) 504 and a domain specific part(s) 506, may be trained using input data 508 (e.g., training input data). The input data 508 may include, but is not limited to, text data, audio data, video data, image data, and/or any other type of data. In some examples, the input data 508 is associated with one or more general domains, such as when the base model(s) 504 of the machine learning model(s) 502 is being trained. In some examples, the input data 508 is associated with a specific domain, such as when one of the domain specific part(s) 506 is being trained.

The machine learning model(s) 502 may be trained using the input data 508 as well as corresponding ground truth data 510. The ground truth data 510 may include annotations, labels, masks, and/or the like. In some embodiments, self-supervised training may be used to train the model(s), such as by using one or more self-supervised loss functions. For example, the ground truth data may be the same as the input data, but shifted by one position, such that the model is asked to predict a next token corresponding to the shifted input data. However, in other examples, semi-supervised or unsupervised training—using corresponding loss functions—may be implemented.

In some examples, the ground truth data 510 may be generated within a drawing program (e.g., an annotation program), a computer aided design (CAD) program, a labeling program, another type of program suitable for generating the ground truth data 510, and/or may be hand drawn, in some examples. In some examples, the ground truth data 510 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 512 may include one or more loss functions that measure loss (e.g., error) in outputs 514 as compared to the ground truth data 510. Any type of loss function may be used, such as cross entropy loss, mean squared error, mean absolute error, mean bias error, and/or other loss function types. In some embodiments, different outputs 514 may have different loss functions. In such examples, the loss functions may be combined to form a total loss, and the total loss may be used to train (e.g., update the weights and/or parameters of) the machine learning model(s) 502. In any example, backward pass computations may be performed to recursively compute gradients of the loss function(s) with respect to training parameters. In some examples, weight and biases of the machine learning model(s) 502 may be used to compute these gradients.

As described herein, the training engine 512 may be configured to update the weights and/or parameters associated with the base model(s) 504, without updating the weights and/or parameters of the domain specific part(s) 506, when the base model(s) 504 is being trained. Additionally, when training a domain specific part 506, the training engine 512 may be configured to update the weights and/or parameters of the domain specific part 506 without updating the weights and/or parameters of the other domain specific part(s) 506. Additionally, and while also training the domain specific part 506, the training engine 512 may be configured to update the weights and/or parameters of one or more of the layers of the base model(s) 504 without updating the weights and/or parameters of one or more other layers of the base model(s) 504.

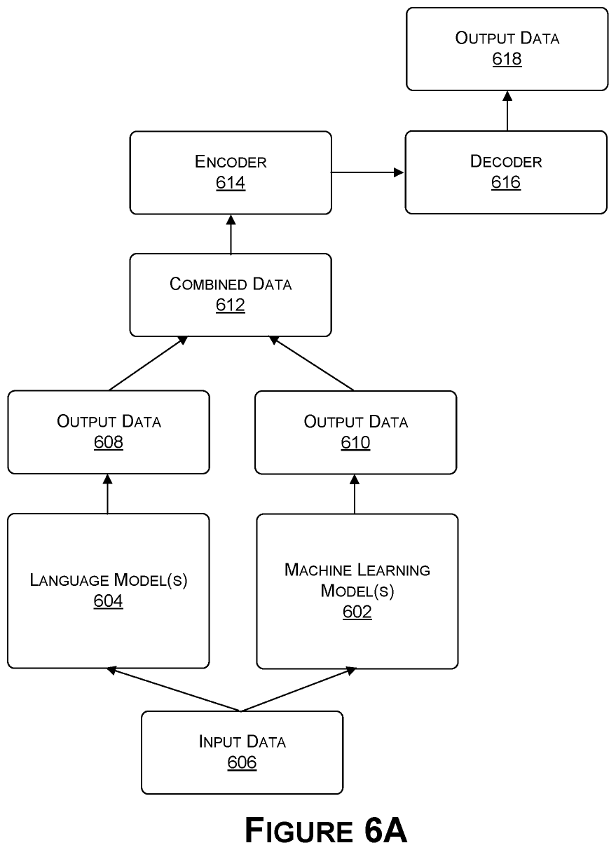

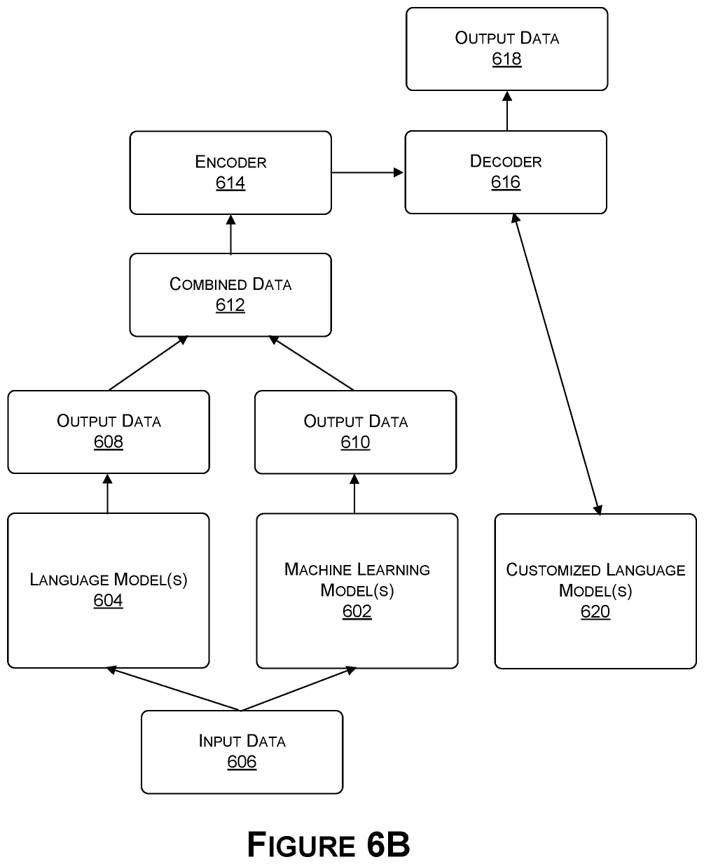

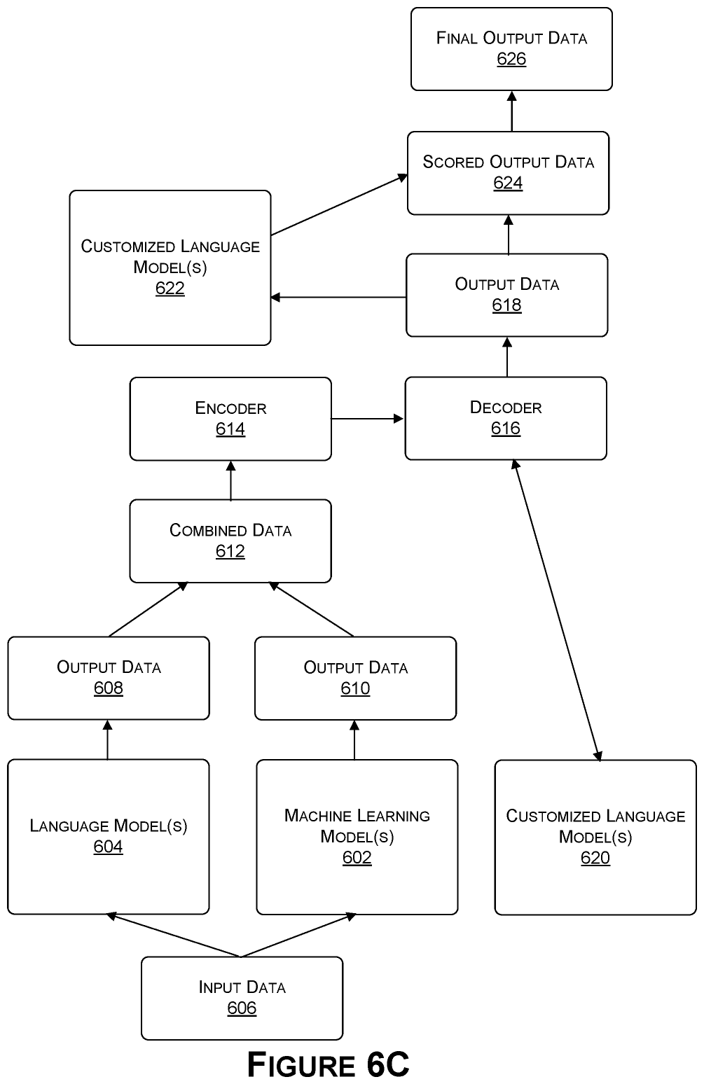

As further described herein, in some examples, the machine learning model(s) may be deployed with one or more other models. For instance, FIG. 6A illustrates an example of deploying a machine learning model(s) 602 (which may represent, and/or include, the machine learning model(s) 102, the machine learning model(s) 202, the machine learning model(s) 302, and/or the machine learning model(s) 502) with one or more other models, in accordance with some embodiments of the present disclosure.

In the example of FIG. 6A, the machine learning model(s) 602 may be deployed with a language model(s) 604. For example, the machine learning model(s) 602 may be added to the encoder and decoder parts of the language model(s) 604. In some examples, the language model(s) 604 may be associated with translating text, such as from a first language to a second language. In such examples, input data 606 for the language model(s) 604 may represent the text in the first language. The language model(s) 604 then processes the input data 606 in order to generate a first output 608. To process the input data 606, the language model(s) 604 may use a pretrained named entity recognition model (NER) that annotates the named entities represented by the input data 606, where the named entities are replaced by dummy placeholder tokens. Next, a pre-trained neural language model(s) may encode the processed sequence. After the processing of the sequence, an encoded tensor representation is post-processed by a feature extractor so that the domain specific information is weighted higher in the total sequence.

The machine learning model(s) 602 may then process the domain specific information represented by the input data 606. Similar to the language model(s) 604, a masked language model inference may be applied to the input sequence and a tensor representation of the inputs may be obtained. Based on the processing, the machine learning model(s) 602 may output data 610. The first tensor representation of the output data 608 and the second tensor representation of the output data 610 may then be combined (e.g., concatenated) to generated combined data 612. Next, the combined data 612 may be processed by another encoder 614 and decoder 616 in order to generate final output data 618. In this example, the final output data 618 may represent a translation of the input data 606.

In other examples, the language model(s) 604 may include another type of language model, such as speech process model (e.g., an automatic speech recognition (ASR) model, a natural-language understanding (NLU) model, etc.). In such examples, the input data 606 may represent audio data, such as audio data representing user speech. As such, the language model(s) 604 may be configured to process the input data 606 for general voice information while the machine learning model(s) 602 may be configured to process the input data 606 to help process the domain specific information.

For instance, based on processing the input data 606 for the general voice information, the language model(s) 604 may output data 608 representing a first tensor representation. Additionally, based on processing the domain specific information, the machine learning model(s) 602 may output data 610 representing a second tensor representation. Similar to the example above, the first tensor representation of the output data 608 and the second tensor representation of the output data 610 may then be combined (e.g., concatenated) to generate combined data 612. Next, the combined data 612 may be processed by the other encoder 614 and decoder 616 in order to generate final output data 618. In this example, the final output data 618 may represent text, such as text that represents a user speech represented by the input data 606.

FIG. 6B illustrates an example of deploying an additional customized language model(s) 620 with the machine learning model(s) 602 and the language model(s) 604, in accordance with some embodiments of the present disclosure. In the example of FIG. 6B, the customized language model(s) 620 may be applied to the decoder 616. As such, the customized language model(s) 620 may process the outputs from the decoder 616 for better handling of the domain specific information. For instance, the customized language model(s) 620 may use cross-attention to integrate the tensor representation output by the encoder 614. In some examples, such as when the decoder 616 outputs a list of outputs associated with processing the input data 606, the customized language model(s) 620 may provide output for selecting at least one of the outputs for the final output data 618.

FIG. 6C illustrates an example of deploying an additional customized language model(s) 622 with the machine learning model(s) 602, the language model(s) 604, and the customized language model(s) 620, in accordance with some embodiments of the present disclosure. In the example of FIG. 6C, the output data 618 from the decoder 616 may represent a list of outputs (e.g., a list of hypothesis), such as two outputs, five outputs, ten outputs, twenty outputs, and/or any other number of outputs. The customized language model(s) 622 may then be configured to process the list of outputs in order to rank the list of outputs.

In some examples, to rank the list of outputs, the customized language model(s) 622 may determine one or more scores for the list of the outputs (e.g., determine a respective score for each output). In such examples, the customized language model(s) 622 may determine a score by the following equation:

score=orig_score+alpha+nim_score+beta*seq_length (1)

In equation (1), orig_score is a first score calculated by the decoder 616 (e.g., calculated by the customized language model(s) 620), nim_score is calculated by the customized language model(s) 622, alpha is a first parameter used to adjust the importance of the nim_score, seq_length is the length of the output, and beta is a second parameter used to adjust the importance of the seq_length. Based on the scoring, scored output data 624 may be generated, where the scored output data 624 represents the ranked outputs. Using the scored output data 624, final output data 626 may be generated that represents one or more of the outputs. For examples, the final output data 626 may represent the output with the highest score.

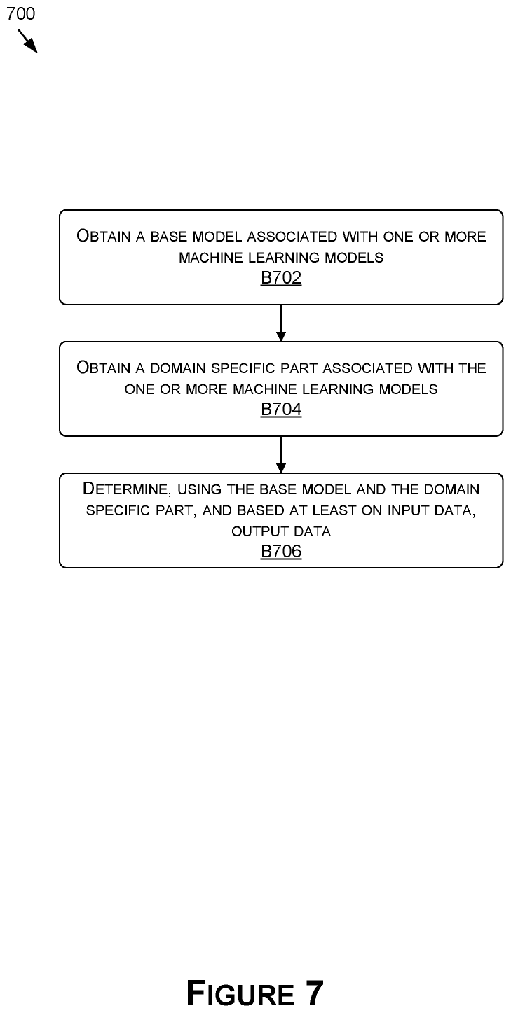

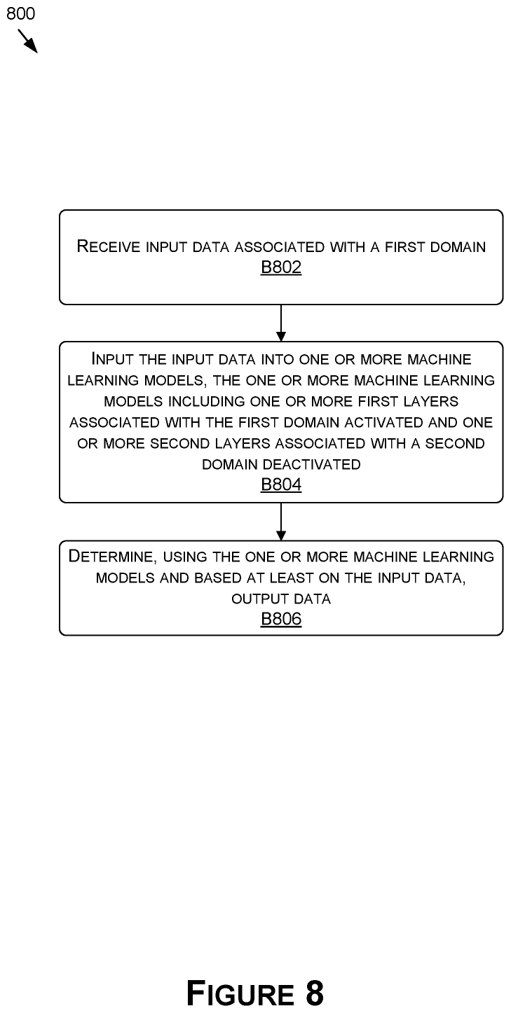

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods 700 and 800 may also be embodied as computer-usable instructions stored on computer storage media. The methods 700 and 800 may be provided by a standalone application, a service or hosted service (standalone or in combination with another hosted service), or a plug-in to another product, to name a few. In addition, the methods 700 and 800 are described, by way of example, with respect to the system of FIGS. 1A-1B. However, the methods 700 and 800 may additionally or alternatively be executed by any one system, or any combination of systems, including, but not limited to, those described herein.

FIG. 7 is a first flow diagram showing a first method 700 for deploying a machine learning model(s) that includes a base model(s) and a domain specific part(s), in accordance with some embodiments of the present disclosure. The method 700, at block B702, may include obtaining a base model associated with one or more machine learning models. For instance, a device (e.g., a system, a machine, a server, etc.) may receive and/or retrieve the base model(s) 104. As described herein, the base model(s) 104 may be trained to understand general domains.

The method 700, at block 704, may include obtaining a domain specific part associated with the one or more machine learning models. For instance, the device may receive and/or retrieve the domain specific part 106 that is associated with a specific domain, where the domain specific part 106 includes one or more layers. In some examples, the device may receive and/or retrieve the domain specific part 106 along with the base model(s) 104. In some examples, the device may receive and/or retrieve the domain specific part 106 separately from receiving and/or retrieving the base model(s) 104. Still, in some examples, the device may receive and/or retrieve multiple domain specific parts 106 associated with multiple specific domains.

The method 700, at block B706, may include determining, using the base model and the domain specific part, and based at least on input data, output data. For instance, the input data may be processed using the base model(s) 104 and the domain specific part 106. In some examples, the input data is associated with the specific domain for which the domain specific part 106 was trained. The base model(s) 104 and the domain specific part 106 may then process the input data and, based on the processing output data associated with the input data.

FIG. 8 is a second flow diagram showing a second method 800 for deploying a machine learning model(s) that includes a base model(s) and a domain specific part(s), in accordance with some embodiments of the present disclosure. The method 800, at block B802, may include receiving input data associated with a first domain. For instance, a system(s) may receive the first data associated with the first domain. As described herein, in some examples, the input data may include text, such as text including one or more letters, words, sub-words, characters, numbers, tokens, and/or symbols, that is generated using an input device and/or generated as a transcript of spoken language. However, in other examples, the input data may include another type of data, such as image data, video data, audio data, and/or any other type of data that may be processed by one or more machine learning models.

The method 800, at block B804, may include inputting the input data into one or more machine learning models, the one or more machine learning models including one or more first layers associated with a first domain activated and one or more second layers associated with a second domain deactivated. For instance, the input data may be input into the machine learning model(s) 102—which may include a large language model (LLM), in embodiments. As described herein, the machine learning model(s) 102 may include at least the domain specific part 106(1) that is associated with the first domain and the second domain specific part 106(2) that is associated with the second domain, where each domain specific part 106 includes one or more layers. Since the input data is associated with the first domain, the domain specific part 106(1) may be activated while the domain specific part 106(2) may be deactivated.

The method 800, at block B806, may include determining, using the one or more machine learning models and based at least on the input data, output data. For instance, based on the domain specific part 106(1) being activated, the input data may be processed using the base model(s) 104 and the domain specific part 106(1). However, since the domain specific part 106(2) is deactivated, the input data may not be processed using the domain specific part 106(2). Additionally, based on the processing, the machine learning model(s) 102 may generate the output data associated with the input data.

### Example Computing Device

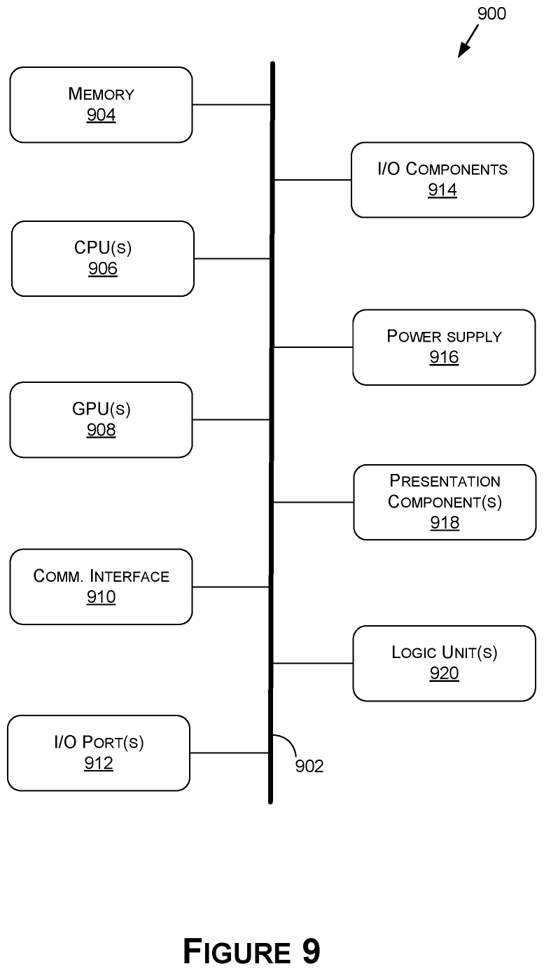

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCle) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

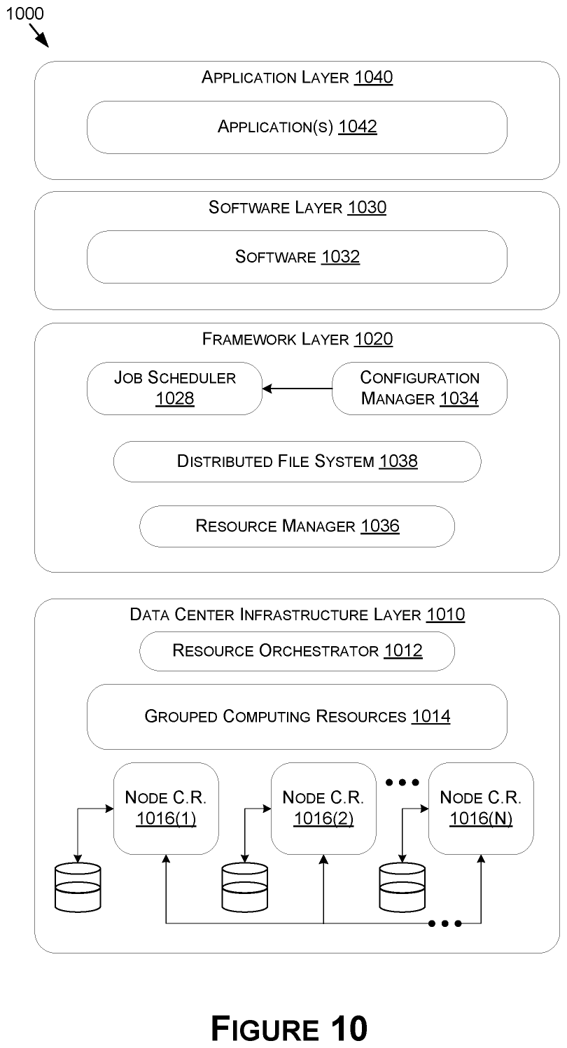

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining a base model associated with one or more machine learning models;
obtaining a domain specific part associated with the one or more machine learning models; and
determining, based at least on the base model and the domain specific part processing input data, an output associated with the input data.

2. The method of claim 1, further comprising:
obtaining a second domain specific part associated with the one or more machine learning models,
wherein the determining the output associated with the input data is without using the second domain specific part in the processing of the input data.

3. The method of claim 1, further comprising:
determining that the input data is associated with a specific domain; and
based at least on the input data being associated with the specific domain, causing the domain specific part to be coupled to the base model,
wherein the determining the output associated with the input data occurs while the domain specific part is coupled to the base model.

4. The method of claim 3, wherein the determining that the input data is associated with the specific domain comprises at least one of:
receiving, from a user device, an indication that the input data is associated with the specific domain; or
analyzing the input data to determine that the input data is associated with the specific domain.

5. The method of claim 3, wherein the causing the domain specific part to be coupled to the base model comprises causing one or more first layers associated with the domain specific part to be coupled to one or more second layers associated with the base model.

6. The method of claim 1, further comprising:
updating, using first training data associated with one or more general domains, one or more first parameters of one or more first layers associated with the base model; and
updating, using second training data associated with a specific domain, one or more second parameters of one or more second layers associated with the domain specific part.

7. The method of claim 6, further comprising:
during the updating using the first training data, refraining from updating the one or more second parameters of the one or more second layers associated with the domain specific part; and
during the updating using the second training data, refraining from updating the one or more first parameters of the one or more first layers associated with the base model.

8. The method of claim 1, further comprising:
determining, using one or more second machine learning models, a second output associated with the input data; and
determining, based at least on the output and the second output, a third output associated with the input data.

9. The method of claim 8, wherein the determining the third output associated with the input data comprises:
determining, based at least on the output and the second output, the third output associated with the input data and a fourth output associated with the input data;
determining, using one or more third machine learning models, a first score associated with the third output and a second score associated with the fourth output; and
determining the third output based at least on the first score being greater than the second score.

10. A system comprising:
one or more processing units to:
receive input data associated with a domain;
processing the input data using one or more machine learning models to generate an output, the one or more machine learning models including one or more first layers associated with a base model and one or more second layers associated with the domain; and
perform one or more operations using the output.

11. The system of claim 10, wherein the one or more machine learning models further include one or more third layers associated with a second domain, and wherein the one or more processing units are further to:
cause the one or more second layers to be activated and the one or more third layers to be deactivated,
wherein the output is generated when the one or more second layers are activated and the one or more third layers are deactivated.

12. The system of claim 11, wherein the one or more processing units are further to determine to activate the one or more second layers and deactivate the one or more third layers based at least on one or more of:
receiving, from a user device, an indication to at least one of activate the one or more second layers or deactivate the one or more third layers; or
analyzing the input data to determine that the input data is associated with the domain.

13. The system of claim 11, wherein the one or more second layers are caused to be activated and the one or more third layers are caused to be deactivated based at least on:
a first memory component associated with the one or more second layers being connected to the one or more first layers associated with the base model; and
a second memory component associated with the one or more third layers being disconnected from the one or more first layers associated with the base model.

14. The system of claim 10, wherein the input data is input into the one or more machine learning models at a first time, and wherein the one or more processing units are further to:
receive second input data associated with a second domain;
input the second input data into the one or more machine learning models at a second time, the one or more machine learning models including the one or more first layers associated with the base model and one or more third layers associated with the second domain at the second time; and
determine, using the one or more machine learning models and based at least one the second input data, a second output associated with the second input data.

15. The system of claim 10, wherein the one or more processing units are further to:
determine, using one or more second models, a second output associated with the input data; and
determine, based at least on the output and the second output, a third output associated with the input data.

16. The system of claim 10, wherein the one or more processing units are further to:
update, using first training data associated with one or more general domains, one or more first parameters associated with the one or more first layers without updating one or more second parameters associated with the one or more second layers; and
update, using second training data associated with the domain, the one or more second parameters associated with the one or more second layers without updating the one or more first parameters associated with the one or more first layers.

17. The system of claim 10, wherein the system is comprised in at least one of:
an infotainment system for an autonomous or semi-autonomous machine;
an entertainment system for an autonomous or semi-autonomous machine;
a system for performing simulation operations;
a system for hosting real-time streaming applications;
a system for generating content for one or more of virtual reality (VR), augmented reality (AR), or mixed reality (MR);
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to determine, using one or more machine learning models and based at least on input data associated with a first domain, an output associated with the input data, wherein the one or more machine learning models include one or more first layers associated with the first domain activated and one or more second layers associated with a second domain deactivated.

19. The processor of claim 18, wherein the one or more processing units are further to: activate the one or more first layers and deactivate the one or more second layers based at least on one or more of:
receiving, from a user device, an indication to at least one of activate the one or more first layers or deactivate the one or more second layers; or
analyzing the input data to determine that the input data is associated with the first domain.

20. The processor of claim 18, wherein the processor is comprised in at least one of:
an infotainment system for an autonomous or semi-autonomous machine;
an entertainment system for an autonomous or semi-autonomous machine;
a system for performing simulation operations;
a system for hosting real-time streaming applications;
a system for generating content for one or more of virtual reality (VR), augmented reality (AR), or mixed reality (MR);
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
